(19) United States
(12) Patent Application Publication
(10) Pub. No.: US 2023/0377016 A1
(43) Pub. Date: Nov. 23, 2023

(54) METHODS AND SYSTEMS FOR OPTIMIZING FILTERS IN PRODUCT SEARCHING

(71) Applicant: COUPANG CORP., Seoul (KR)

(72) Inventors: Nishant Agrawal, Sunnyvale, CA (US); Kai Deng, San Jose, CA (US); Daewon Kang, Yongin-si (KR); Hyunjun Jeon, Paju-si (KR); Andrei Alikov, Seoul (KR); Vladimir Solomenchuk, Palo Alto, CA (US); Wonki Jung, Seoul (KR); Nam Gyun Jo, Seoul (KR); Chan Seo, Seoul (KR); Jin Hyeong Park, Seoul (KR); Narae Kwak, Seoul (KR)

(73) Assignee: COUPANG CORP., Seoul (KR)

(21) Appl. No.: 17/747,239

(22) Filed: May 18, 2022

(51) Int. Cl. G06Q 30/06

(52) U.S. Cl. CPC G06Q 30/0625; G06Q 30/0641; G06Q 30/0633

(57) ABSTRACT

Methods and system for generating a filter interface in response to a user search are disclosed. The method includes extracting keywords from a search term, determining a plurality of filters associated with the keywords, determining a ranking for each of the plurality of filters, providing and displaying, based on the ranking, a subset of the plurality of filters as exposed filters, receiving a user selection of one of the exposed filters, in response to the second user input, applying the one of the plurality of filters and updating the ranking of the remaining of the plurality of filters, updating, to the first user, the search result, and regenerating the plurality of filters. The methods and system further includes methods to determine the ranking and filter arrangements on the user interface, and methods to update filters.

### TECHNICAL FIELD

The present disclosure generally relates to computerized systems and methods for providing and updating optimized filters to search results. In particular, embodiments of the present disclosure relate to inventive and unconventional systems relate to efficient data processing in order to providing, updating, and displaying optimal filters on a user interface.

### BACKGROUND

Consumers conduct searches online to locate products and product information. During this process, it is common practice to provide filters to facilitate and narrow down the search. Filters may narrow down search results by applying additional restrictions in addition to the search term.

Present day online shopping may make a large variety of products available for customers to choose from. A group of similar products may come from different manufacturers, have different configurations in one of many aspects, have different prices, including product selling prices and shipping costs, or different warranty terms, etc. A filter may be applied to each of the differences. The number of available filters may thus be astronomical. Every user may have a different goal and therefore may need different filters, or may consider one set of filters more relevant to another. Having a full list of available filters for all products thus may only work in theory, because the ability to meet an individual user's need is questionable. Some alternative approaches include allowing users to conduct further searches within results. However, users may not always know the exact terms to conduct the most efficient and relevant follow-up searches.

Moreover, it is not practical to manually maintain the large number of filters. Applying one filter may dynamically change the applicability of the rest of the filters, and may expose user intent. It is impossible to efficiently maintain and update applicable filters without an efficient and effective system and method.

Therefore, there is a need for improved methods and systems for providing and updating users with optimized filters applicable to search results in a user-friendly way, as well as updating filters to reflect the trends of the market and consumer tastes.

### SUMMARY

One aspect of the present disclosure is directed to a system for generating a filter interface, the system comprising at least one storage device comprising instructions, and at least one processor configured to execute the instructions. The instructions comprise the steps of: extracting at least one keyword from a first user input from a user, the first user input is a search term, determining a plurality of filters associated with the at least one keyword, the plurality of filters being stored on the at least one storage, determining a ranking for each of the plurality of filters, providing, based on the ranking, a first subset of the plurality of filters for the first user, saving an arrangement of the first subset of the plurality of filters for the first user to a cache, providing, to the first user, a search result based on the at least one keywords, receiving a second user input, wherein the second user input is a selection of one of the plurality of filters, in response to the second user input, applying the one of the plurality of filters, updating the ranking of the remaining of the plurality of filters, maintaining, by fetching from the cache, the arrangement of the first subset of the plurality of filters, updating, to the first user, the search result, and regenerating the plurality of filters.

Another aspect of the present disclosure is directed to a method for generating a filter interface. The method comprises the steps of: extracting at least one keyword from a first user input from a user, the first user input is a search term, determining a plurality of filters associated with the at least one keyword, the plurality of filters being stored on the at least one storage, determining a ranking for each of the plurality of filters, providing, based on the ranking, a first subset of the plurality of filters for the first user, saving an arrangement of the first subset of the plurality of filters for the first user to a cache, providing, to the first user, a search result based on the at least one keywords, receiving a second user input, wherein the second user input is a selection of one of the plurality of filters, in response to the second user input, applying the one of the plurality of filters, updating the ranking of the remaining of the plurality of filters, maintaining, by fetching from the cache, the arrangement of the first subset of the plurality of filters, updating, to the first user, the search result, and regenerating the plurality of filters.

Yet another aspect of the present disclosure is directed to extracting at least one keyword from a first user input from a user, the first user input is a search term, determining, among the at least one keywords, a stem keyword, wherein the search result is based on the stem keyword, determining, among the at least one keywords, user-defined limitations, determining a plurality of filters associated with the at least one keyword, the plurality of filters being stored on the at least one storage, searching for a pre-determined filter configuration from the at least one storage, matching the user-defined limitations to the plurality of filters, applying the matched filters to the search results, determining a ranking for each of the plurality of filters; wherein each of the plurality of filters are assigned a usefulness score stored on the at least one storage; and the ranking is based on the usefulness score, determining at least one filters in the first subset of the plurality of filters being parallel options, arranging the parallel options in a group, saving the arrangement of the parallel options in the group in a cache, providing, based on the ranking, a first subset of the plurality of filters for the first user, saving an arrangement of the first subset of the plurality of filters for the first user to a cache, providing, to the first user, a search result based on the at least one keywords, providing, to the first user, a user interface element, when selected, displays all of the plurality of filters, receiving a second user input, wherein the second user input is a selection of one of the plurality of filters, in response to the second user input, applying the one of the plurality of filters, updating the ranking of the remaining of the plurality of filters, updating the usefulness score based on the second user input, maintaining, by fetching from the cache, the arrangement of the first subset of the plurality of filters, updating, to the first user, the search result, and regenerating the plurality of filters by determining an applicability of the remaining filters of the plurality of filters, determining, based on the applicability of the remaining of the plurality of filters, a second subset of the plurality of filters, maintaining, by fetching from the cache, the arrangement of the parallel options in the group, and updating, to the first user, the second subset of the plurality of filters as unavailable.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary process to respond to a user search and subsequent filter application and updates.

FIG. 4 is a diagrammatic illustration of an exemplary process to analyze a user input (search term.)

FIG. 5A is an exemplary illustration of the exposed filters of a search as shown to a user.

FIG. 5B is an exemplary illustration of the exposed filters of the search in FIG. 5A after user selecting a filter.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for providing, updating, and displaying filters to search results on a user interface.

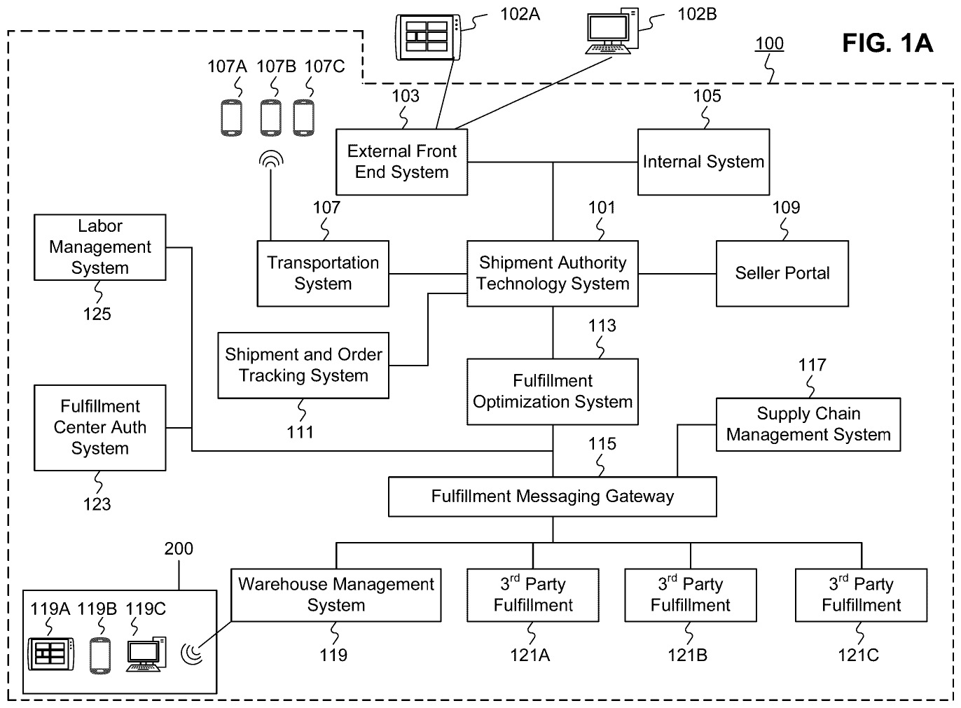

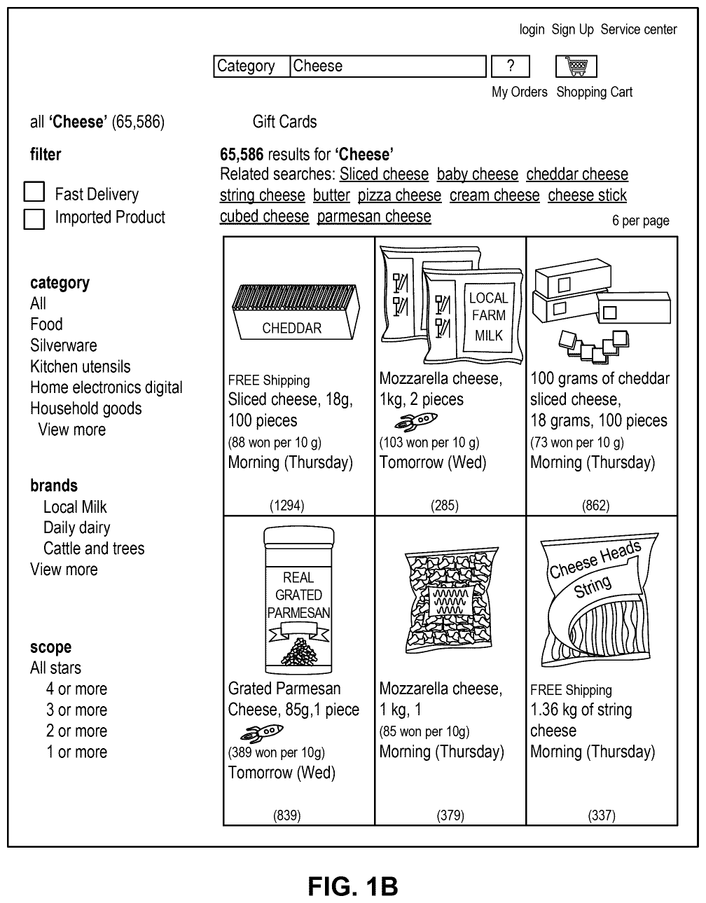

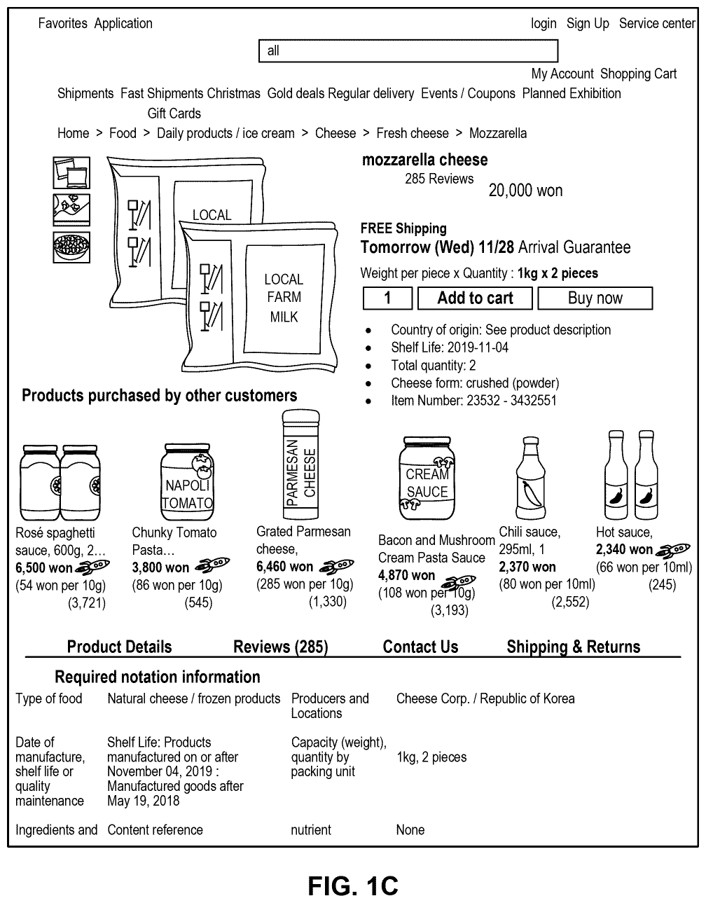

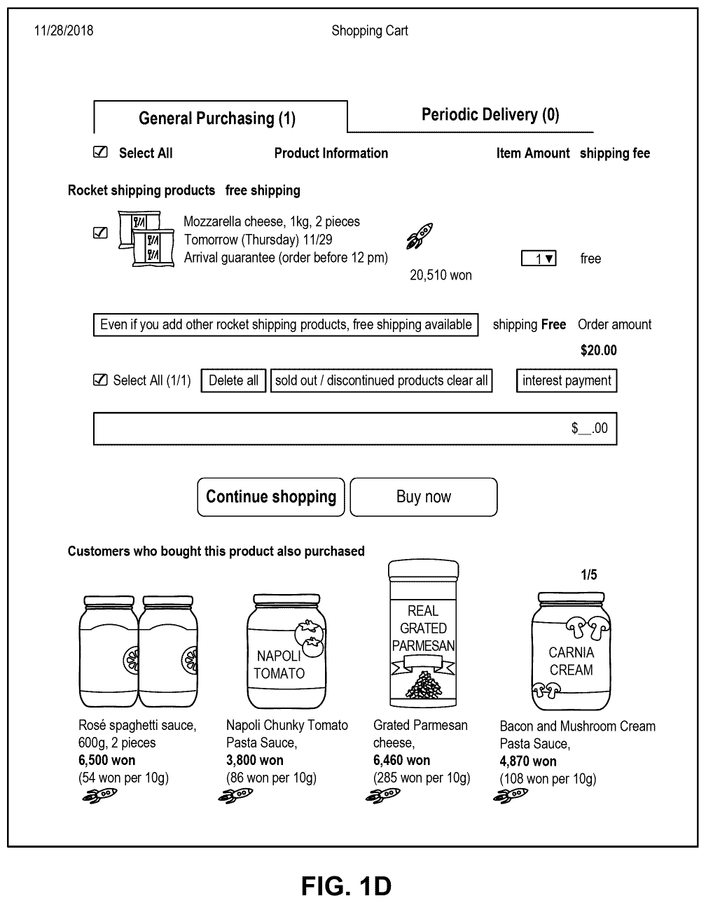

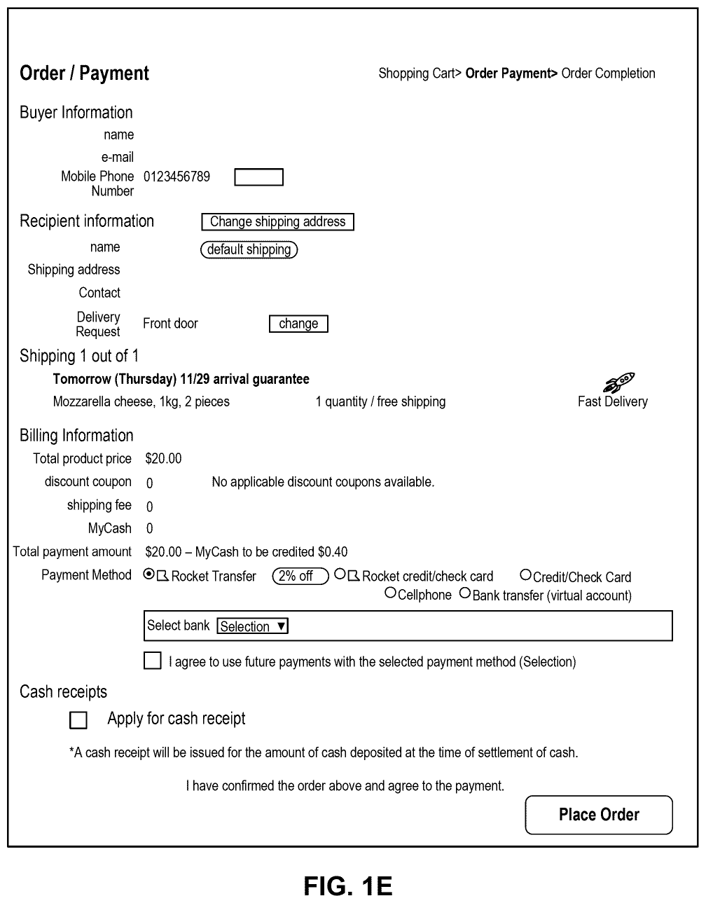

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal system 105 may be implemented as a web server that enables internal users to view diagnostic and statistical information about orders, modify item information, or review statistics relating to orders. For example, internal system 105 may be implemented as a computer or computers running software such as the Apache HTTP Server, Microsoft Internet Information Services (IIS), NGINX, or the like. In other embodiments, internal system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal system 105 may include one or more of a web caching system, a database, a search system, a payment system, an analytics system, an order monitoring system, or the like. In one aspect, internal system 105 may comprise one or more of these systems, while in another aspect, internal system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

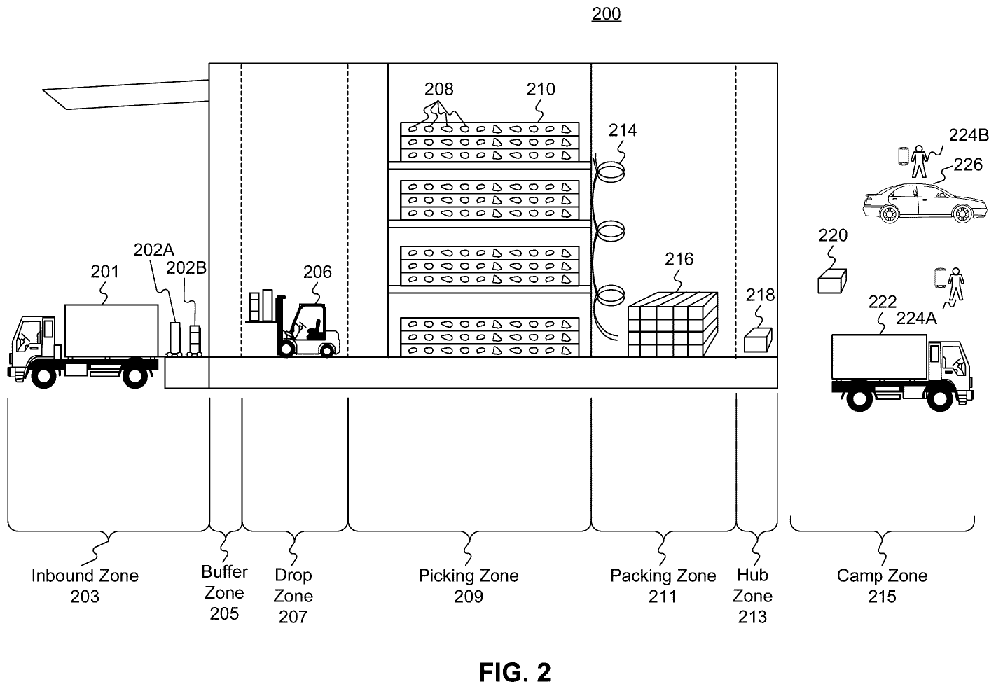

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

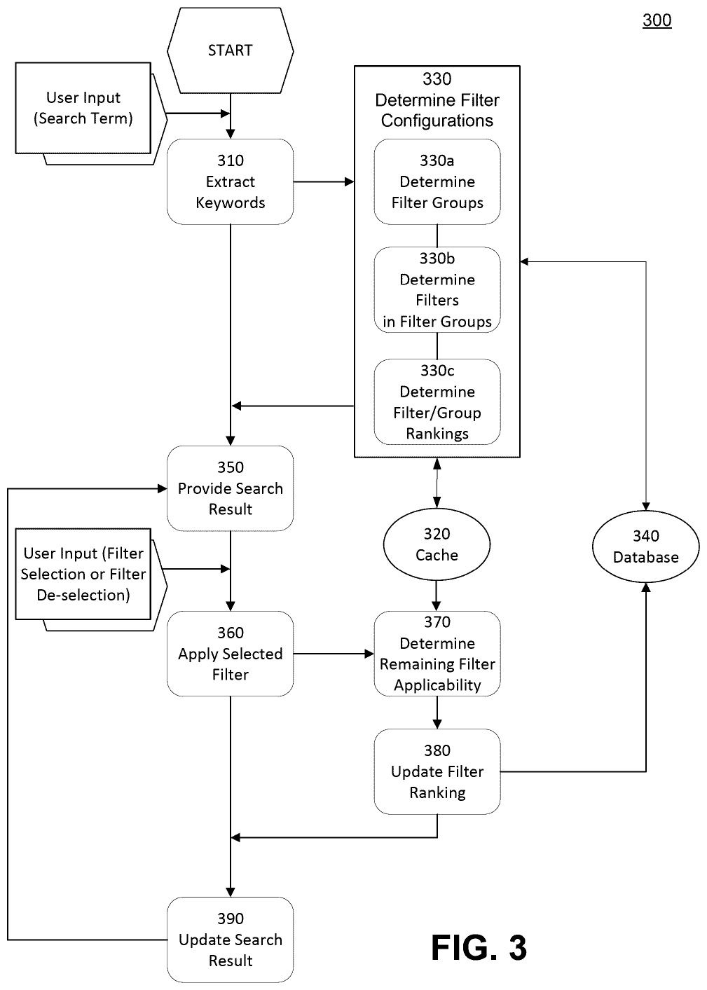

FIG. 3 is a diagrammatic illustration of an exemplary process 300 to respond to a user search and subsequent filter application and updates. User may initiate a search by providing a search term through External Front End System 103. A user device (e.g., using mobile device 102A or computer 1026) may navigate to external front end system 103 and request a search by entering information into a search box. External front end system 103 may request information from one or more systems in system 100. For example, external front end system 103 may request information from internal system 105, among other systems, that satisfies the search request.

In step 310, the search term may be analyzed by at least one processor so at least one keyword is extracted from the search term.

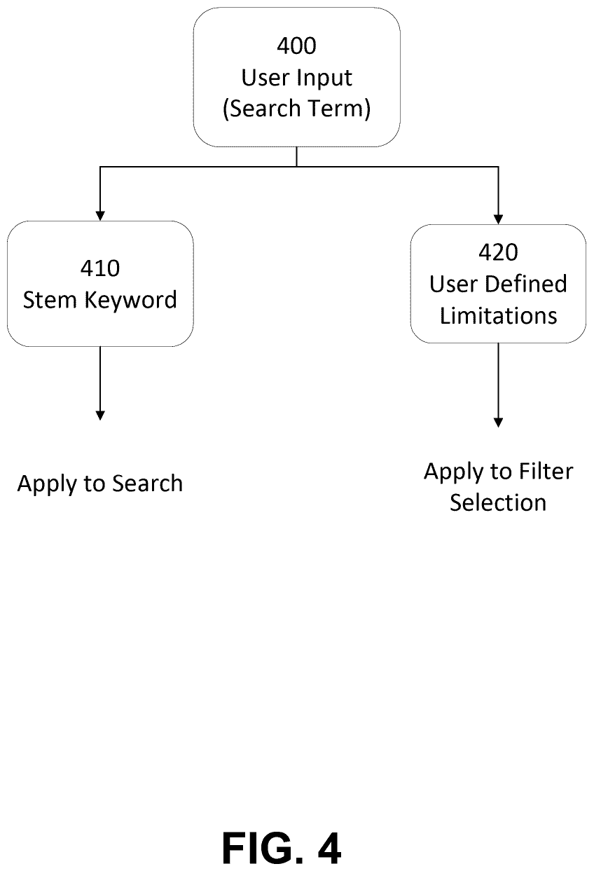

In some embodiments (for example, as shown in FIG. 4, described below), the search term 400 may be further analyzed to determine a stem keyword 410 and additional limitations 420. The application of the stem keyword 410 and additional limitations 420 is discussed in later sections of this disclosure.

In some embodiments, the extracted keywords may be used to conduct a search by internal system 105. In some embodiments, the search result may be temporarily stored in a cache 320 as a raw search result before further processed with filter applications. The cache 320 may be, for example, a raw file, a temporary database, or a database entry/entries that saves data temporarily for a search session or user session.

In step 330, internal system 105 may query a database 340 to determine if a filter configuration associated with the extracted keywords already existed. The database 340 may be stored on a server, e.g., internal system 105. In some embodiments, when a filter configuration associated with the extracted keywords exists, internal system 105 may use this filter configuration in future steps (e.g., step 370), and store the filter configuration into cache 320.

In some embodiments, filter configurations may be stored in the database 340 or other storage media alike. Filter configurations may be associated with a product, a type of products or a keyword. In some embodiments, filter configurations may be created manually by an authorized personnel using one of the internal system 105. The authorized personnel may create filter configurations based on a specific type of products, based on a keyword, or based on merely a concept with a category of products. This means that the filter configuration creation process may be done by the authorized personnel at any time, regardless of the status of the associated products or keywords. For example, before or after the associated products arrived in stock, before or after the associated products are established in WMS 119, or before or after the associated products are established in SCM system 117. In some embodiments, the filter configurations may be created and updated by earlier searches.

In some embodiments, filter configurations may be expanded or updated. The expansion and update of filter configurations may be performed manually by an authorized user or automatically by internal system 105. In some embodiments, when the expansion and update of filter configurations are being conducted by the authorized user, the authorized user may or may not be the same user who created the filter configurations. In some embodiments, the user selection of filters may be recorded and used to update the ranking of the filters. In some embodiments, the applicability of the remaining filters may be used to update the ranking of the filters.

In some embodiments, the filter configuration comprises applicable filters and their respective rankings, and grouping information.

In some embodiments, internal system 105 may determine that a filter configuration is already available in the database 340 of the internal system 105. The filter configuration may then be stored in cache 320 and applied to the raw search results.

In some embodiments, internal system 105 may determine that a filter configuration is not available in the database 340 of the internal system 105. Internal system 105 may proceed to steps 330a-c to determine filter configurations.

For example, in step 330a, internal system 105 may first determine the relevance of all known filter groups. The known filter groups may come from product information, which is provided to the system 100 when relevant products were established in internal system 105. Additionally or alternatively, the known filter groups may be a product of AI by analyzing the user behaviors. For example, internal system 105 may determine a word in a search term being a limiting word, and designate this limiting word as a filter. For example, internal system 105 may recognize that a product name or attributes of a relevant product includes the term “14-inch laptop,” which has “14-inch” as a limiting word, and thus determine that “14-inch” should be an applicable filter. Internal system 105 may determine this applicable filter and thus the applicable filter group that contains this applicable filter.

In some embodiments, internal system 105 may assign similar filters in a same filter group in step 330b. Similar filters may provide parallel options for a product. For example, a laptop computer may have configurations of different CPU speeds, (e.g., 1.4 GHz, 1.6 GHz, 2.0 GHz., etc.) Filters for these different CPU speeds are considered to be offering parallel options and thus similar filters. These similar filters may be arranged in a same filter group of “CPU speed” and stored in cache 310.

In some embodiments, in step 330c, each filter group may be ranked by an assigned usefulness score, which is stored in the database 340. For example, the laptop computer has several filter groups e.g., CPU speed, screen size, hard drive capacity, etc. Each of these filter groups is assigned a ranking.

In some embodiments, the usefulness score may be calculated by a preset formula with considerations of many factors, for example, click-through rate (CTR), engagement/conversion rate, generated revenue, generated profit, special promotions, etc. In some embodiments, additional interactions with the filters in the filter group may also affect the usefulness score of this filter group. For example, time spent by the user on the subsequent pages, subsequent browsing of the pages, etc. The rankings may or may not be associated with the product/keyword.

A filter group may be assigned multiple rankings, each associated with a different product/keyword. Therefore, the ranking of a filter group is configuration dependent. A filter group may have a different ranking in different filter configurations.

In some embodiments, filters in each filter group may also be ranked.

In step 350, internal system 105 may apply the determined filter configurations to the raw search results and obtain search results that are available for the user who conducted the search. In some embodiments, internal system 105 may decide the filters from a first subset of highest ranked filter groups from all applicable filter groups to be exposed filters. Exposed filters are made to be selectable on the user interface and displayed together with the search results, instead of being folded and hidden (e.g., in a drop-down list, or on a separate page.) Compared to conventional filters, it is very easy for a user to choose an exposed filter.

In some embodiments, as shown in FIG. 4, when user-defined limitations 420 are extracted from the user input search term 400, these limitations may be applied automatically as filter selections by the user. In some embodiments, these user-defined limitations 420 may be applied to the raw search results before exposed filters be determined. Therefore, the user input search term 400 may be determined to have two distinct parts for two different functions. The stem keyword 410 is applied to the initial search to initiate process 300; the user-defined limitations 420 is applied to step 330 to determine filter configurations. For example, when a user input search term was “14-inch laptop computer,” “laptop computer” was determined to be the stem keyword and “14-inch” was determined to be a user-defined limitation. Therefore, the initial search would be conducted to search for laptop computers. 14-inch display would be applied to the raw search results as a filter. The first SRP provided to the user showed filtered search results of laptop computers but only with 14-inch displays. The filters from the filter group that contains 14-inch display are automatically designated as exposed filters, but may not be selectable if they are incompatible with filter selections, e.g., 14-inch display.

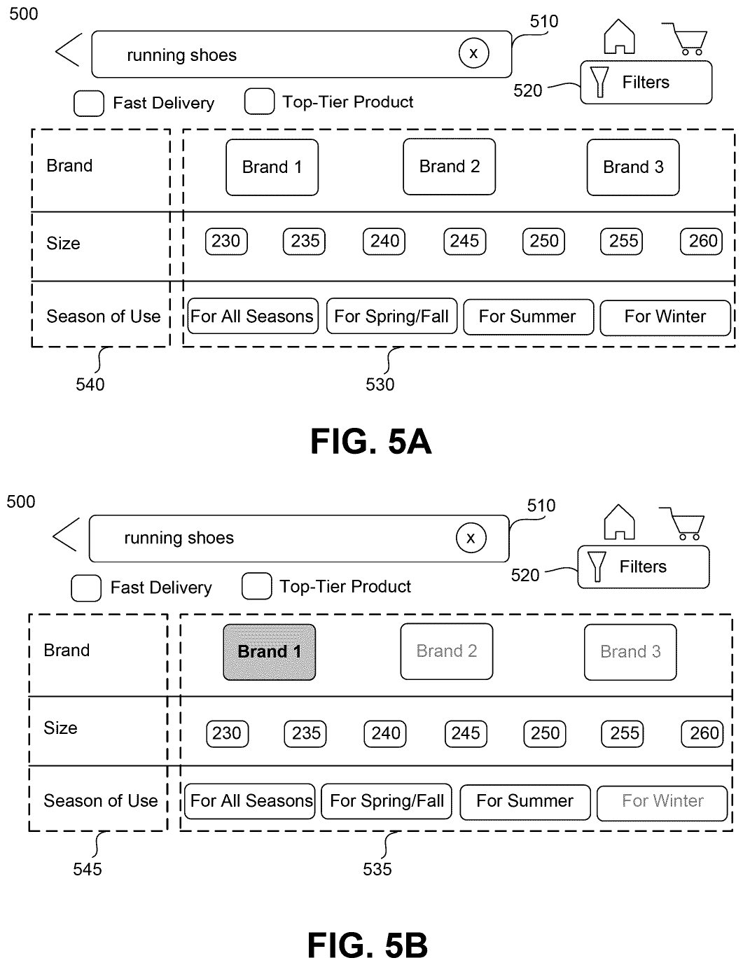

In an exemplary embodiment as shown in FIG. 5A, the user searched, in search box 510, for running shoes, which was determined to be one stem keyword 410 without user-defined limitations 420. On SRP 500, a user may activate filter button 520 to allow all filters be displayed. The determined exposed filters are displayed in groups in section 530. The parallel filters are grouped under different groups in section 540. The filters in section 530 are exposed filters, which are selectable by a simple click, and may not be limited to texts (e.g., logos, pictures, etc.) External front end system 103 may then prepare an SRP (e.g., FIG. 1B) based on the determined exposed filters and search result. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

In step 360, when the user chooses one of the exposed filters, internal system 105 may apply the selected filter to search results. In some embodiments. internal system 105 may hold the updated search results in cache 320 and determine remaining filter's applicability and rankings.

In step 370, internal system 105 may regenerate and re-evaluate all filters in response to the user selection. In some embodiments, all filters and filter groups may be re-evaluated for their rankings and applicability.

In some embodiments, internal system 105 may recognized that the user has expressed his/her mind in a certain way by selecting the selected filter. This selection action may then be used to predict future selections. Rankings of the remaining filters may therefore be adjusted accordingly.

In some embodiments, after applying the selected filter, some filters may no longer be applicable, i.e., when applied may yield no result. Because these filters were available before, not showing them after the regeneration will cause confusion to the user. Therefore, these filters may still be shown but marked as no longer available. In some embodiments, each filter is compared to the original saved filter configurations (i.e., the filter configuration determined before returning search results to the user for the first time, after applying all user-defined limitations, if applicable).

If the filter was applicable in the original filter configuration, but no longer applicable after the regeneration, the filter may be marked as unavailable. In some embodiments, the unavailable filters may be displayed in a different color, (e.g., greyed out) and/or made un-selectable. In some embodiments, the filter arrangement (e.g., the order of the orders and/or filter groups) may be kept the same as in the original filter configuration to not confuse users. In some embodiments, filters and filter groups that yield no search results may be removed or de-ranked.

In an exemplary embodiment as shown in FIG. 5B, user selected an exposed filter “brand 1” from the embodiment shown in FIG. 5A. Since the brands are mutually exclusive, “brand 2” and “brand 3” were greyed-out, but were still displayed in section 535 in the same order as in FIG. 5A. The grouping in section 545 were maintained the same as in FIG. 5A as well. In this example, no result would return if both “brand 1” and “for winter” are applied, therefore the exposed filter “For Winter” is also greyed-out as unselectable.

In step 380, the updated filter configurations, in particular, the rankings of the filter groups, may be saved to the database 340 for future searches. In some embodiments, the rankings are configuration dependent and thus keyword dependent, they are therefore saved with their associated keywords. In some embodiments, internal system 105 may combine similar or associated keywords so they may share a same set of filter group rankings. In some embodiments, the selection of a filter, and the non-selection of a filter, may both affect the ranking of this filter and the filter group it belongs to. In some embodiments, additional interactions with the filter may also affect the ranking of this filter and the filter group it belongs to. For example, the conversion rate, engagement rate, time spent on the subsequent pages, etc.

In some embodiments, internal system 105 may use further user behaviors (e.g., searches, browsing, filter selections, etc.) to detect blind spots of the existing filter configurations. When the user does not apply any exposed filters and resort to un-exposed filters or browsing to select a product, internal system 105 may analyze the user decision and determine if the existing exposed filters fail to cover the product that the user was looking for. Internal system 105 may analyze the selected product and extract keywords from the product attributes to establish additional filters or filter groups, and store these filters or filter groups to database 340.

In step 390, SRP 500 may be updated based on updated filter group ranking and applied selected filter. SRP 500 is then made ready for the next user input (e.g., another filter selection, or filter de-selection). In some embodiments, when a user selects another filter, internal system 105 may loop back to step 350 to repeat the process of determining remaining filter applicability, updating filter group ranking, and updating search result (e.g., steps 360, 370, 380, 390.) In some embodiments, the user may reverse one of the previous filter selection. Internal system 105 may then add back the de-selected filter as a “remaining filter” and repeat the process of determining remaining filter applicability, updating filter group ranking, and updating search result (e.g., steps 360, 370, 380, 390.)

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for generating a filter interface, the system comprising:
at least one storage device comprising instructions;
at least one processor configured to execute the instructions to perform the steps of:
extracting at least one keyword from a first user input from a user, the first user input is a search term;
determining a plurality of filters associated with the at least one keyword, the plurality of filters being stored on the at least one storage;
determining at least one filter groups, each of the at least one filter groups contains at least one of the plurality of filters;
determining a ranking for each of the at least one filter groups;
providing, based on the ranking, a first subset of the plurality of filters for the first user;
saving an arrangement of the first subset of the plurality of filters for the first user to a cache;
providing, to the first user, a search result based on the at least one keywords;
receiving a second user input, wherein the second user input is a selection of one of the plurality of filters;
in response to the second user input, applying the one of the plurality of filters;
updating the ranking of the at least one filter groups;
maintaining, by fetching from the cache, the arrangement of the first subset of the plurality of filters;
updating, to the first user, the search result; and
regenerating the plurality of filters.

2. The system of claim 1, wherein determining a plurality of filters associated with the at least one keyword comprises:
searching for a pre-determined filter configuration from the at least one storage.

3. The system of claim 1, wherein determining at least one filter groups comprises:
determining at least one filters in the first subset of the plurality of filters being parallel options; and
arranging the parallel options in one of the at least one filter groups;
saving the arrangement of the parallel options in the at least one filter groups in a cache.

4. The system of claim 3, wherein the regenerating the plurality of filters comprises:
determining an applicability of the remaining filters of the plurality of filters;
determining, based on the applicability of the remaining of the plurality of filters, a second subset of the plurality of filters;
maintaining, by fetching from the cache, the arrangement of the parallel options in the group; and
updating, to the first user, the second subset of the plurality of filters as unavailable.

5. The system of claim 1, the at least one processor configured to further execute the steps of:
determining, among the at least one keywords, a stem keyword;
wherein the search result is based on the stem keyword;
determining, among the at least one keywords, user-defined limitations;
matching the user-defined limitations to the plurality of filters;
applying the matched filters to the search results.

6. The system of claim 1, wherein:
each of the at least one filter groups is assigned a usefulness score stored on the at least one storage; and
the ranking is based on the usefulness score.

7. The system of claim 6, wherein the at least one processor is further configured to perform the step of updating the usefulness score based on the second user input.

8. The system of claim 6, wherein the usefulness score is determined by click through rate of the corresponding filter.

9. The system of claim 1, the at least one processor configured to further execute the steps of providing, to the first user, a user interface element, when selected, displays all of the plurality of filters.

10. A method for generating a filter interface, the method comprising:
extracting at least one keyword from a first user input from a user, the first user input is a search term;
determining a plurality of filters associated with the at least one keyword, the plurality of filters being stored on the at least one storage;
determining at least one filter groups, each of the at least one filter groups contains at least one of the plurality of filters;
determining a ranking for each of the at least one filter groups;
providing, based on the ranking, a first subset of the plurality of filters for the first user;
saving an arrangement of the first subset of the plurality of filters for the first user to a cache;
providing, to the first user, a search result based on the at least one keywords;
receiving a second user input, wherein the second user input is a selection of one of the plurality of filters;
in response to the second user input, applying the one of the plurality of filters;
updating the ranking of the at least one filter groups;
maintaining, by fetching from the cache, the arrangement of the first subset of the plurality of filters;
updating, to the first user, the search result; and
regenerating the plurality of filters.

11. The method of claim 10, wherein determining a plurality of filters associated with the at least one keyword comprises:
searching for a pre-determined filter configuration from the at least one storage.

12. The method of claim 10, wherein determining at least one filter groups comprises:
determining at least one filters in the first subset of the plurality of filters being parallel options;
arranging the parallel options in one of the at least one filter groups; and
saving the arrangement of the parallel options in the at least one filter groups in a cache.

13. The method of claim 12, wherein the regenerating the plurality of filters comprises:
determining an applicability of the remaining filters of the plurality of filters;
determining, based on the applicability of the remaining of the plurality of filters, a second subset of the plurality of filters;
maintaining, by fetching from the cache, the arrangement of the parallel options in the group; and
updating, to the first user, the second subset of the plurality of filters as unavailable.

14. The method of claim 10, further comprising:
determining, among the at least one keywords, a stem keyword;
wherein the search result is based on the stem keyword;
determining, among the at least one keywords, user-defined limitations;
matching the user-defined limitations to the plurality of filters; and
applying the matched filters to the search results.

15. The method of claim 10, wherein:
each of the at least one filter groups is assigned a usefulness score stored on the at least one storage; and
the ranking is based on the usefulness score.

16. The method of claim 15, further comprising updating the usefulness score based on the second user input.

17. The method of claim 15, wherein the usefulness score is determined by click through rate of the corresponding filter.

18. The method of claim 10, further comprising providing, to the first user, a user interface element, when selected, displays all of the plurality of filters.

19. A method for generating a filter interface, the method comprising:
extracting at least one keyword from a first user input from a user, the first user input is a search term;
determining, among the at least one keywords, a stem keyword;
wherein the search result is based on the stem keyword;
determining, among the at least one keywords, user-defined limitations;
determining a plurality of filters associated with the at least one keyword, the plurality of filters being stored on the at least one storage;
searching for a pre-determined filter configuration from the at least one storage;
matching the user-defined limitations to the plurality of filters;
applying the matched filters to the search results;
determining a ranking for each of the plurality of filters; wherein:
each of the plurality of filters are assigned a usefulness score stored on the at least one storage; and
the ranking is based on the usefulness score;
determining at least one filters in the first subset of the plurality of filters being parallel options;
arranging the parallel options in a group;
saving the arrangement of the parallel options in the group in a cache;
providing, based on the ranking, a first subset of the plurality of filters for the first user;
saving an arrangement of the first subset of the plurality of filters for the first user to a cache;
providing, to the first user, a search result based on the at least one keywords;
providing, to the first user, a user interface element, when selected, displays all of the plurality of filters;
receiving a second user input, wherein the second user input is a selection of one of the plurality of filters;
in response to the second user input, applying the one of the plurality of filters;
updating the ranking of the remaining of the plurality of filters;
updating the usefulness score based on the second user input;
maintaining, by fetching from the cache, the arrangement of the first subset of the plurality of filters;
updating, to the first user, the search result; and
regenerating the plurality of filters by:
determining an applicability of the remaining filters of the plurality of filters;
determining, based on the applicability of the remaining of the plurality of filters, a second subset of the plurality of filters;
maintaining, by fetching from the cache, the arrangement of the parallel options in the group; and
updating, to the first user, the second subset of the plurality of filters as unavailable.
